(19) United States
(12) Patent Application Publication
(10) Pub. No.: US 2006/0268364 A1
(43) Pub. Date: Nov. 30, 2006

(54) Systems and methods for determining user preferences and/or facsimile device capabilities before call initiation

(76) Inventors: Michael A. Oliszewski, Sherwood, OR (US); Athir Nuaimi, Toronto (CA); Christopher C. Moore, Seattle, WA (US)

Correspondence Address: PRESTON GATES ELLIS & ROUVELAS MEEDS LLP, 1735 NEW YORK AVENUE, NW, SUITE 500, WASHINGTON, DC, 20006, US

(21) Appl. No.: 11/430,961

(22) Filed: May 10, 2006

Related U.S. Application Data
(60) Provisional application No. 60/679,231, filed on May 10, 2005.

(51) Int. Cl. H04N 1/00

(52) U.S. Cl. 358/468; 358/448; 358/402

(57) ABSTRACT

Disclosed herein are systems and methods that can improve the quality and efficiency of document facsimile transmission. Quality can be improved by allowing a facsimile document sender to view the document as it will be transmitted to a receiving facsimile device. Efficiency of facsimile transmission is improved by providing systems and methods that allow the transmitting facsimile device to determine the capabilities and/or preferences associated with the receiving facsimile device and convert the facsimile document to match those capabilities and/or preferences before a call is placed.

### CROSS REFERENCES TO RELATED APPLICATIONS

This application claims the benefit under 35 U.S.C. § 119, of U.S. Provisional Patent Application Ser. No. 60/679,231 filed May 10, 2005, the contents of which are incorporated herein by reference.

### FIELD OF THE INVENTION

This invention relates to electronic facsimile devices. More specifically, the invention relates to managing varying user preferences and/or common capabilities used by facsimile devices. More specifically, the invention relates to predetermining, as opposed to negotiating, user preferences and/or common capabilities between communicating facsimile devices.

### BACKGROUND OF THE INVENTION

Electronic facsimile (commonly known as FAX) transmission has become a popular and convenient method for sending documents to remote users. The electronic facsimile device and its associated protocol allows a first user to convert a document (through optical scanning or data conversion) for electronic transmittal to a second user over a publicly available communications network such as, for example, a Public Switched Telephone Network (PSTN) or computer data network.

While facsimile transmission is a convenient method for sending documents, there is room for improvement in the efficiency and quality of document transmission. For example, as facsimile machines currently are used, different user's machines often have different capabilities. Varying capabilities include those related to, for example and without limitation, color, resolution, baud rate and compression formats. In one scenario, for example, a sender with a transmitting facsimile device with color capabilities may assume that the receiving facsimile device also has these capabilities. If this assumption is not correct, however, the facsimile may be transmitted in black and white. In many cases, such assumptions and changes to the transmitted document may not have large consequences. In some cases, however, it may be essential for the sender of a document to know in advance how the document will be received.

Another drawback associated with the varying capabilities between transmitting and receiving facsimile devices as they currently are used is that the transmitting and receiving facsimile devices must negotiate a set of common capabilities at the beginning of the actual facsimile call. Once common capabilities are identified, the document to be transmitted must be converted into the negotiated formats. This call-based negotiation of capabilities and subsequent document conversion has significant efficiency drawbacks. For example, negotiating common capabilities and conducting subsequent document conversion is time inefficient (incurring extra call-length associated costs) and requires extra computational power (to perform multiple conversions of a document). Further, and as stated earlier, under this protocol, a user transmitting a document will not be able to preview the document as it will be transmitted under the negotiated set of capabilities to ensure that the transmitted document is of acceptable quality before the facsimile call (and capability negotiation) is placed. Based on these identified problems, there is room for improvement in the efficiency and quality of facsimile document transmission.

### SUMMARY OF THE INVENTION

In view of the above-identified problems, the present invention provides for more efficient facsimile transmission. Thus, it is an object of the present invention to circumvent the aforementioned problem of lengthened facsimile call-length (and associated costs) and additional computational overhead required due to the need to prepare and/or convert the document to be transmitted into a format acceptable to both facsimile devices, and in one embodiment, their users, during the facsimile call. In another embodiment, it is a further object of the invention to provide the transmitting user the capability to preview the facsimile-compatible document before transmission so that this user can determine the acceptability of the document quality before placing the facsimile call.

To achieve the foregoing and other objectives of the present invention, systems and methods for determining common capabilities, and in one embodiment user preferences, between transmitting and receiving facsimile devices before a call is placed are described herein. Determining common capabilities (and user preferences if provided) in advance of placing a call saves time and computational power required during placement of the call. Determining common capabilities (and user preferences if provided) before call placement can also allow the transmitting user to preview the document as it will be transmitted to the receiving facsimile device. These advancements in facsimile transmissions improve the efficiency and quality of facsimile document transmittals.

The systems and methods of the present invention accomplish the aforementioned objectives by using, in one embodiment, one or more of a combination of: (i) a transmitting facsimile device capable of at least both converting a source document into a facsimile compatible format and placing a call to a receiving facsimile device; (ii) a receiving facsimile device capable of receiving a call and accepting a facsimile transmission; (iii) a database management device for processing stored data; (iv) a database capable of storing facsimile capability data and/or receiving-user preferences of receiving facsimile devices identified by a unique addressing identifier (such as, for example and without limitation, a PSTN phone number) associated with the receiving device; (v) a mutual data communication method between the transmitting facsimile device and the database management device (such as, for example and without limitation, a LAN or WAN); and (vi) a data communication network that is available for the transmitting facsimile device and the receiving facsimile device to mutually communicate.

In one embodiment according to the present invention, the unique addressing identifier of a particular receiving facsimile device is entered into the transmitting facsimile device. A source document intended for transmittal to the receiving facsimile device is also supplied to the transmitting facsimile device. The transmitting facsimile device communicates the unique addressing identifier to the database management device. The database management device refers to the database to determine particular receiving facsimile device capabilities associated with the unique addressing identifier thereby determining the capabilities of the receiving facsimile device associated with the unique addressing identifier. In one embodiment, a receiving-user may also have inputted its preferences within its device's capabilities for receiving facsimile transmissions. The receiving-user can select and enter “global” preferences applied to all incoming transmissions or can select and enter different preferences associated with different transmitting facsimile devices (through a transmitting facsimile device's own unique addressing identifier). The database management device then communicates the receiving facsimile device capabilities (and receiving-user preferences, if provided) to the transmitting facsimile device. The transmitting facsimile device converts the source document to a facsimile compatible format that is within the capabilities of both the transmitting and receiving facsimile devices. In one embodiment, the document can then be viewed in its facsimile compatible format by the transmitting user to determine if it is acceptable before a call is placed.

Specifically, one embodiment of the present invention comprises a method of providing a database capable of storing data regarding specified capabilities of a plurality of receiving facsimile devices wherein the database links the specified capabilities of the receiving facsimile devices with each the receiving facsimile device's unique addressing identifier; enabling a database management device to link to the database and wherein the database management device processes the data stored in the database; allowing a transmitting facsimile device to communicate a unique addressing identifier to the database management device through a mutual data communication network wherein the database management device then determines the specified capabilities of the receiving facsimile device associated with the unique addressing identifier by referencing the stored data within the database and communicates the specified capabilities of the receiving facsimile device to the transmitting facsimile device. In another embodiment, the database can store a receiving-user's preferences within its device's capabilities. These preferences can be “global” and applied to all incoming transmissions to the receiving facsimile device or can selective with different preferences associated with different transmitting facsimile devices.

In another embodiment of the methods of the present invention, a source document for transmittal to the receiving facsimile device is supplied to the transmitting facsimile device; and the transmitting facsimile device converts the source document to a facsimile compatible format within the specified capabilities (and/or preferences) of the receiving facsimile device and the native capabilities of the transmitting facsimile device.

In another embodiment of the methods of the present invention, the transmitting facsimile device further transmits the converted document to the receiving facsimile device.

In another embodiment of the methods of the present invention, mutual data communication occurs through, without limitation, the use of LAN or WAN.

In another embodiment of the methods of the present invention, the unique addressing identifier is a phone number. In another embodiment of the methods of the present invention, the unique addressing identifier is an IP address.

In another embodiment of the methods of the present invention, the document conversion occurs through the use of a digital optical scan of a physical document. In another embodiment of the methods of the present invention, the document conversion occurs through the use of an algorithmic conversion of a known digital document type.

In another embodiment of the methods of the present invention, the database is updatable to reflect a change in preferences and/or capabilities associated with a receiving facsimile device. In another embodiment of the methods of the present invention, the source document is reconverted to a facsimile document based on the changed preferences and/or capabilities of the receiving facsimile device.

In another embodiment of the methods of the present invention, the database is updatable to add records for capabilities of a receiving facsimile device when these capabilities are determined not to be in the database.

In another embodiment of the methods of the present invention, a preview of the converted facsimile document is provided to the transmitting user. In another embodiment of the methods of the present invention, the preview is supplied by a video display. In another embodiment of the methods of the present invention, the preview is supplied by a printed physical document.

In another embodiment of the methods of the present invention, the transmitting user can terminate the facsimile transmittal. In another embodiment of the methods of the present invention, the facsimile transmittal is terminated independently of the transmitting user based on preselected attribute criteria.

In another embodiment of the methods of the present invention, the system is equipped to reiteratively execute a plurality of facsimile transmittals in a batch process. In another embodiment of the methods of the present invention, the conversion of the source document is optimized for each individual instance of the plurality of facsimile transmittals. In another embodiment of the methods of the present invention, the conversion of the source document is optimized for capabilities common to all instances of the plurality of facsimile transmittals.

In another embodiment of the methods of the present invention, the specified preferences and/or capabilities include, without limitation, one or more of transmission speed, transmission cost, availability, security parameters, color, resolution, baud rate, compression format, and combinations thereof.

One embodiment of the present invention is a system comprising a database capable of storing data regarding specified capabilities of a plurality of receiving facsimile devices wherein the database links the specified capabilities of the receiving facsimile devices with each the receiving facsimile device's unique addressing identifiers; and a database management device to link to the database wherein the database management device processes the data stored in the database, and wherein a transmitting facsimile device can communicate a unique addressing identifier to the database management device through a mutual data communication network, wherein the database management device then determines the specified capabilities of the receiving facsimile device associated with the unique addressing identifier by referencing the stored data within the database and communicates the specified capabilities of the receiving facsimile device to the transmitting facsimile device. In another embodiment the database also includes the receiving-user's global (applied to all incoming facsimile transmissions) or selective (applied to facsimile transmissions sent from particular transmitting facsimile devices) preferences for receiving facsimile transmissions.

In another embodiment of the systems of the present invention, a transmitting user further supplies the transmitting facsimile device with a source document for transmittal to the receiving facsimile device and the transmitting facsimile device converts the source document to a facsimile compatible format within the specified preferences and/or capabilities of the receiving facsimile device and the native capabilities of the transmitting facsimile device.

In another embodiment of the systems of the present invention, the transmitting facsimile device further transmits the converted document to the receiving facsimile device.

In another embodiment of the systems of the present invention, mutual data communication occurs through the use of, without limitation, LAN or WAN.

In another embodiment of the systems of the present invention, the unique addressing identifier is a phone number. In another embodiment of the systems of the present invention, the unique addressing identifier is an IP address.

In another embodiment of the systems of the present invention, document conversion occurs through the use of a digital optical scan of a physical document. In another embodiment of the systems of the present invention, the document conversion occurs through the use of an algorithmic conversion of a known digital document type.

In another embodiment of the systems of the present invention, the database is updatable to reflect a change in receiving-user's preference or the capabilities of a receiving facsimile device. In another embodiment of the systems of the present invention, the source document is reconverted to a facsimile document based on the changed preferences and/or capabilities associated with a receiving facsimile device. In another embodiment of the systems of the present invention, the database is updatable to add capabilities of receiving facsimile devices when the capabilities are determined not to be in the database.

In another embodiment of the systems of the present invention, a preview of the converted facsimile document is provided to the transmitting user. In another embodiment of the systems of the present invention, the preview is supplied by a video display. In another embodiment of the systems of the present invention, the preview is supplied by a printed physical document. In another embodiment of the systems of the present invention, the user can terminate the facsimile transmittal. In another embodiment of the systems of the present invention, the facsimile transmittal can be terminated independently of the transmitting user based on preselected attribute criteria.

In another embodiment of the systems of the present invention, the system is equipped to reiteratively execute a plurality of facsimile transmittals in a batch process. In another embodiment of the systems of the present invention, the conversion of the source document is optimized for each individual instance of the plurality of facsimile transmittals. In another embodiment of the systems of the present invention, the conversion of the source document is optimized for capabilities common to all instances of the plurality of facsimile transmittals.

In another embodiment of the systems of the present invention, the specified preferences and/or capabilities include one or more of color, resolution, baud rate and compression format.

### BRIEF DESCRIPTION OF THE DRAWINGS

FIG. 1 depicts a block diagram illustrating one embodiment of the systems of the present invention

FIG. 2 depicts an overall flow chart representing one embodiment of the methods of the present invention used to transmit a facsimile document.

FIG. 3 depicts a flow chart representing one embodiment of the methods of the present invention used to transmit a facsimile document. In this embodiment, the method includes functionality for updating existing database information.

FIG. 4 depicts a flow chart representing one embodiment of the methods of the present invention used to transmit a facsimile document. In this embodiment, the method includes functionality for adding new information to the database.

FIG. 5 depicts a flow chart representing one embodiment of the methods of the present invention used to transmit a facsimile document. In this embodiment, the method includes functionality for supplying the user with a preview of the converted facsimile document.

### DETAILED DESCRIPTION OF THE INVENTION

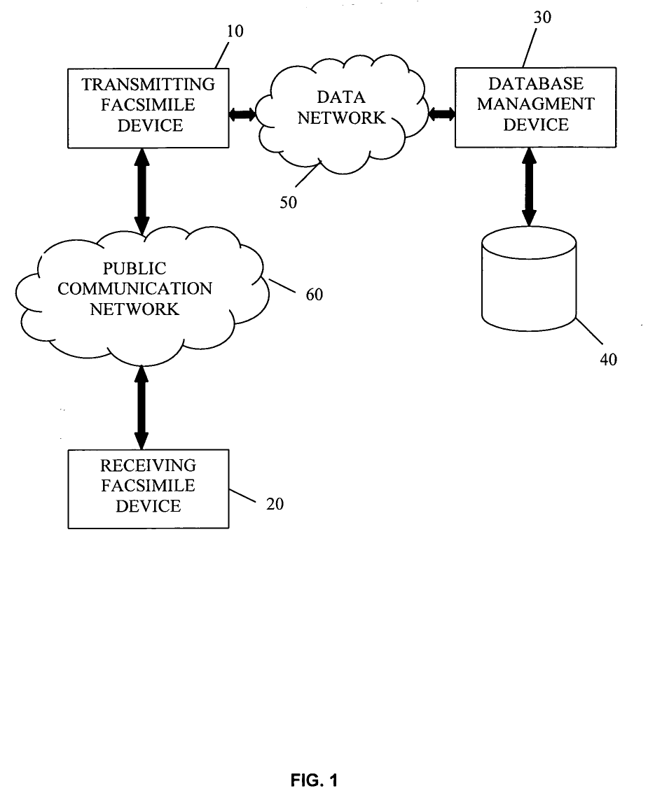

Referring to the Figures, FIG. 1 depicts (i) a transmitting facsimile device 10 capable of converting a source document into a facsimile compatible format and placing a call to a receiving facsimile device 20; and (ii) a database management device 30 for processing stored data associated with a database 40 able to store facsimile device capability data (and in one embodiment receiving-user preferences) of a plurality of receiving facsimile devices (such as 20) that are each identified by one or more unique addressing identifiers. FIG. 1 also depicts a mutual data communication network 50 between the facsimile transmitting device and the database management device (such as, for example and without limitation, a LAN or WAN) and a publicly available communication network 60 (such as, for example and without limitation, a PSTN telephone network) for the transmitting facsimile device 10 and the receiving facsimile device 20 to mutually communicate.

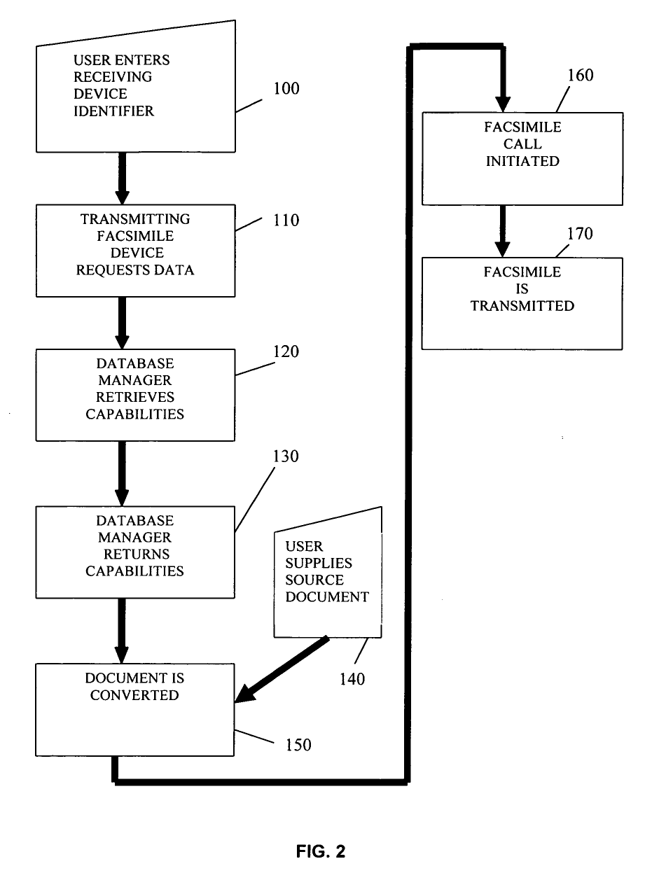

FIG. 2 depicts the basic operational flow of one embodiment of the systems of the present invention. FIG. 2 should be referenced in conjunction with FIG. 1. In operation, at step 100, a unique addressing identifier of the receiving facsimile device 20 is entered into the transmitting facsimile device 10, in one embodiment by a transmitting user. At step 110 the transmitting facsimile device 10 polls the database by communicating the unique addressing identifier to the database management device 30 through the supplied data communications networks 50. In step 120, the database management device 30 refers to the database 40 and retrieves the particular facsimile capabilities associated with the unique addressing identifier thereby determining the capabilities of its associated receiving facsimile device 20. At this stage, in one embodiment, the database can also determine if the receiving-user associated with the particular receiving facsimile device has chosen particular preferences within the particular receiving device's capabilities for use in the facsimile transmission. In step 130, the database management device 30 communicates the capabilities (and/or preferences) of the receiving facsimile device 20 to the transmitting facsimile device 10.

In step 140, a user supplies the transmitting facsimile device 10 with a source document intended for transmittal to the receiving facsimile device 20. While this step is said to occur at step 140 in the embodiment described in FIG. 2, in other embodiments, the user could supply the source document to the facsimile transmitting device at any time prior to step 150.

In step 150, the transmitting facsimile device 10 converts the source document to a facsimile compatible format that is within the capabilities of both the transmitting and receiving facsimile devices 10 and 20 (and in one embodiment, within pre-identified preferences). It is to be understood that in the case of a plurality of mutual capabilities between the transmitting and receiving facsimile devices 10 and 20, a selection logic can also be employed to preferentially select a set of capabilities suitable to optimize a desired parameter of the facsimile call such as image quality or call length (and associated time or connection cost).

In step 160, the transmitting facsimile device 10 initiates a facsimile call through an available communications network 60. In step 170, the transmitting facsimile device 10 transmits the converted, facsimile document to the receiving facsimile device 20.

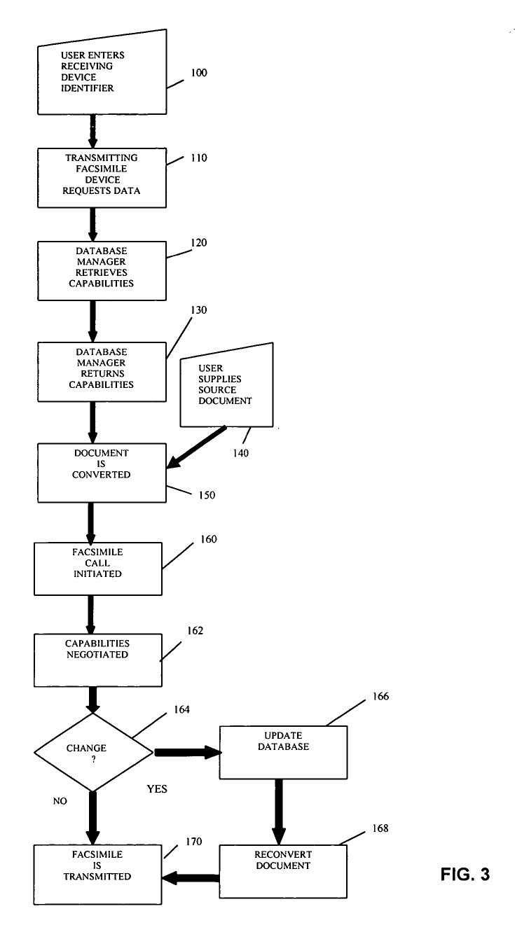

FIG. 3 depicts an alternative embodiment of the systems and methods of the present invention. FIG. 3 should be referenced in conjunction with FIG. 1. FIG. 3 and the embodiment depicted therein share many of the same steps and features as those depicted in FIG. 2. The embodiment depicted in FIG. 3 includes the additional feature of allowing the database 40 to be updated when the capabilities of the receiving facsimile device 20 or the preferences of its user have changed since the last time a call was placed to the particular receiving facsimile device (due to, for example, an equipment upgrade). In Step 162, the preferences and/or capabilities of the receiving facsimile device are negotiated upon call initiation. Such negotiations are understood by those of ordinary skill in the art and implied in the current ITU T.30 or ITU T.38 electronic facsimile protocols. In step 164, the negotiated receiving facsimile device preferences and/or capabilities are compared to the receiving facsimile device capabilities stored in the database 40 and communicated by the database management device 30 in step 130. If the negotiated receiving facsimile device capabilities and the stored receiving facsimile device capabilities are identical (demonstrating no change to the receiving facsimile device capabilities) the process is selectively routed to step 170 and the facsimile document is transmitted in a manner consistent with the process depicted in FIG. 2. If, however, the negotiated receiving facsimile device capabilities and the stored receiving facsimile device capabilities are different (demonstrating a change to the receiving facsimile device capabilities) the process is selectively routed to step 166 wherein the database 40 is updated with the negotiated receiving facsimile device capabilities replacing the stored receiving facsimile device capabilities for the database record associated with the unique addressing identifier of the particular receiving facsimile device 20. If such an update occurs, in one embodiment the receiving-user associated with the device associated with the unique addressing identifier can be notified and given an opportunity to create or update receiving-user preferences in the database. While this step is said to occur at step 166 in the embodiment described in FIG. 3, in other embodiments, the database 40 could be updated at any time after step 164 including (but not limited to) after the facsimile document transmittal in step 170. In step 168, the facsimile document converted in step 150 is reconverted to match the negotiated preferences and/or capabilities of the facsimile receiving device 20. It is to be understood that in the case of a plurality of mutual capabilities between the transmitting and receiving facsimile devices 10 and 20, a selection logic can be employed to preferentially select a set of capabilities suitable to optimize a desired parameter of the facsimile call such as image quality or call length (and associated time or connection cost). In step 170, the transmitting facsimile device transmits the converted, facsimile document to the receiving facsimile device 20.

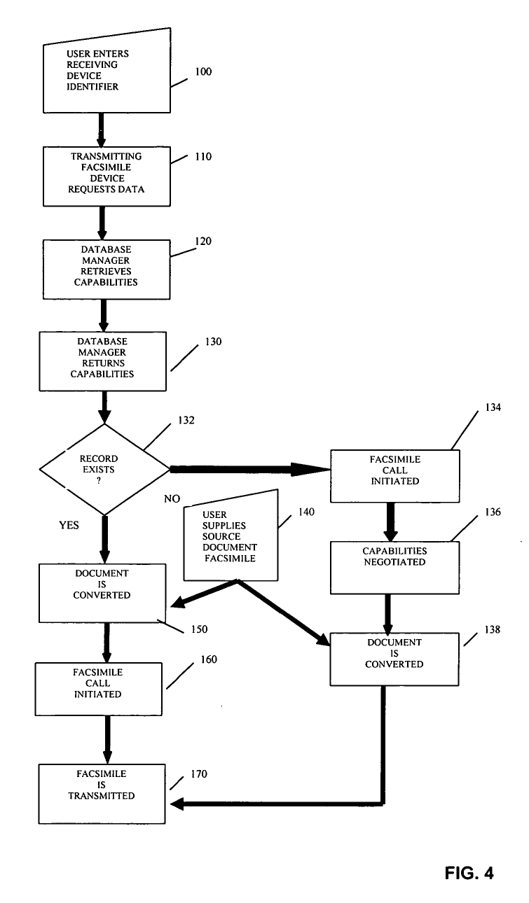

FIG. 4 depicts another embodiment of the methods of the present invention. FIG. 4 should be referenced in conjunction with FIG. 1. This embodiment shares many of the same steps and features as those embodiments described in FIGS. 2 and 3 and the shared features will not be repetitively described in detail. FIG. 4 depicts an embodiment of the methods of the present invention that include the additional feature of allowing the database 40 to be updated with a new record for a receiving facsimile device 20 when it is determined that the receiving facsimile device 20 has no unique addressing identifier in the database 40. In Step 132, the process flow is selectively routed based on the receiving facsimile device capabilities communicated by the database management device 30 in step 130. If the receiving facsimile device capabilities are communicated as existing in the database 40, the process flow is directed to step 150 and the facsimile transmittal proceeds through aforementioned steps 150; 160 and 170 in a manner consistent with the process depicted in FIG. 2. If, however, the receiving facsimile device capabilities are communicated as not existing in the database 40 (through such methods as a NULL value or other identifiers known to those of ordinary skill in the art), the process flow is directed to step 134. In step 134, a facsimile call is initiated by the transmitting facsimile device 10. In Step 136, the capabilities of the receiving facsimile device 20 are negotiated upon call initiation. Such negotiations are understood by those of ordinary skill in the art and are implied in the current ITU T.30 or ITU T.38 electronic facsimile protocols. In step 138, the source document supplied by the user in aforementioned step 140 is converted to a facsimile document based on the receiving facsimile device 20 capabilities negotiated in step 136. While this step is said to occur at step 140 in the embodiment described in FIG. 4, in other embodiments, the user could supply the source document to the facsimile transmitting device at any time prior to step 138. In step 170, the transmitting facsimile device transmits the converted, facsimile document to the receiving facsimile device 20.

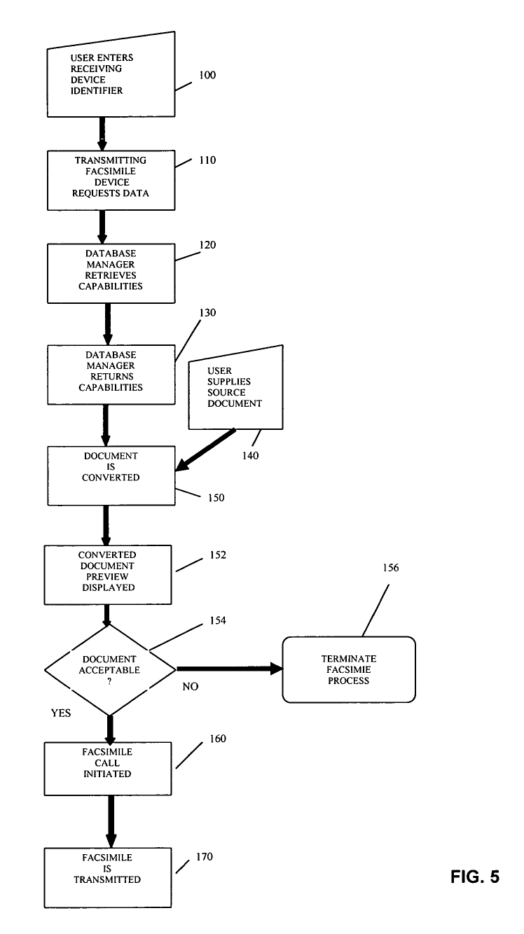

FIG. 5 depicts another alternative embodiment of the methods of the present invention. FIG. 5 should be referenced in conjunction with FIG. 1. Again, the embodiment depicted in FIG. 5 shares many of the same features depicted in previously-described embodiments and redundant steps or features are not repetitively described in detail. The embodiment depicted in FIG. 5 includes the additional feature of allowing the user to preview the facsimile document converted in step 150 based on the common preferences and/or capabilities between the transmitting and receiving facsimile devices 10 and 20. At this point, the transmitting user may selectively continue or abort the facsimile transmittal. In step 152, the facsimile document is displayed by any convenient manner such as, for example and without limitation, a video display, for example on a computer monitor, or a printed physical copy. This preview allows the user to inspect the converted facsimile document for acceptable conversion resolution or other qualitative measures. In step 154, the process flow is selectively routed to allow the facsimile document to be transmitted or to have its transmittal terminated. If the facsimile document is of suitable quality (as determined by the transmitting user) the process is user-selectively routed (by methods known to those of ordinary skill in the art such as a prompted keystroke) to step 170 and the facsimile document is transmitted in a manner consistent with the process depicted in FIG. 2. If, however, the facsimile document is not of suitable quality (as determined by the transmitting user) the process is user-selectively routed (by methods known to those of ordinary skill in the art such as a prompted keystroke) to step 156 which terminates the process leaving the facsimile untransmitted and with no facsimile call placed. While this step is said to be user selective and qualitative in the embodiment described in FIG. 5, in other embodiments, the user could enter minimal requirements for document transmittal at an earlier time, such as before step 100. If a particular transmittal would not meet the predetermined requirements, transmittal could be aborted between steps 100 and 170 without user intervention or input.

In yet another embodiment, the source document originating with the transmitting facsimile device for transmittal to the receiving facsimile device is converted to a facsimile compatible format within the specified preferences and/or capabilities of the receiving facsimile device and the native capabilities of the transmitting facsimile device so as to minimize facsimile transmittal time so as to maximize cost savings. When a receiving-user enters preferences, these preferences can be, without limitation, global or selective and can include preferences based on one or more of color, resolution, baud rate and compression format.

Based on this detailed description it should be clear that the present invention encompasses a method comprising providing a database capable of storing data regarding specified capabilities of a plurality of receiving facsimile devices wherein the database links the specified capabilities of the receiving facsimile devices with each the receiving facsimile device's unique addressing identifier; enabling a database management device to link to the database wherein the database management device processes the data stored in the database; allowing a transmitting facsimile device to communicate a unique addressing identifier to the database management device through a mutual data communication network wherein the database management device then determines the specified capabilities of the receiving facsimile device associated with the communicated unique addressing identifier by referencing the stored data within the database and communicates the specified capabilities of the receiving facsimile device to the transmitting facsimile device. In addition to receiving facsimile device capabilities, in one embodiment, the database also can store receiving-user preferences within its device's capabilities for use during facsimile transmission. Receiving-user preferences can be based on, without limitation, one or more of transmission speed, transmission cost, availability, security parameters, color, resolution, baud rate, compression format, and combinations thereof. Mutual data communication can occur through the use of, without limitation, LAN or WAN. Unique addressing identifiers can be, without limitation, a phone number or an IP address.

Methods of the present invention can further comprise a transmitting user supplying the transmitting facsimile device with a source document for transmittal to the receiving facsimile device; wherein the transmitting facsimile device converts the source document to a facsimile compatible format within the specified capabilities (and in one embodiment receiving-user preferences) of the receiving facsimile device and the native capabilities of the transmitting facsimile device. The transmitting facsimile device can then transmit the converted document to the receiving facsimile device if the transmission is not otherwise terminated. Document conversion can occur through, without limitation, the use of a digital optical scan of a physical document or through the use of an algorithmic conversion of a known digital document type.

Databases according to the present invention can add capabilities of a receiving facsimile device when the capabilities are determined not to be in the database, update to reflect a change in capabilities associated with a receiving facsimile device and update to reflect a change in receiving-user preferences associated with a receiving facsimile device. When an addition or update occurs, a source document can be reconverted to a facsimile document based on the changed preferences and/or capabilities of the receiving facsimile device.

Methods according to the present invention also can include presenting a preview a converted facsimile document to the transmitting user. The preview can occur through, without limitation, a video display or a printed physical document. The transmitting user can terminate the facsimile transmittal or the facsimile transmittal can be terminated independently of the transmitting user based on preselected attribute criteria.

In one embodiment of the methods of the present invention, the system is equipped to reiteratively execute a plurality of facsimile transmittals in a batch process. In another embodiment of the methods of the present invention, the conversion of the source document is optimized for each individual instance of the plurality of facsimile transmittals. In another embodiment of the methods of the present invention, the conversion of the source document is optimized for capabilities common to all instances of the plurality of facsimile transmittals.

The present invention also includes systems. In one embodiment the system comprises a database capable of storing data regarding specified capabilities of a plurality of receiving facsimile devices wherein the database links the specified capabilities of the receiving facsimile devices with each the receiving facsimile device's unique addressing identifier; and a database management device to link to the database wherein the database management device processes the data stored in the database, wherein a transmitting facsimile device can communicate a unique addressing identifier to the database management device through a mutual data communication network, wherein the database management device then determines the specified capabilities of the receiving facsimile device associated with the unique addressing identifier by referencing the stored data within the database and communicates the specified capabilities of the receiving facsimile device to the transmitting facsimile device. In one embodiment the database can also include receiving-user preferences for use during facsimile transmission. Receiving-user preferences can be based on, without limitation, one or more of color, transmission speed, transmission cost, availability, security parameters, color, resolution, baud rate, compression format, and combinations thereof.

In these systems, mutual data communication can occur through, without limitation, the use of LAN or WAN. Unique addressing identifiers can include, without limitation, a phone number or an IP address.

In one embodiment, the transmitting facsimile device converts a source document to a facsimile compatible format within the specified capabilities of the receiving facsimile device and the native capabilities of the transmitting facsimile device. Document conversion can occur through, without limitation, the use of a digital optical scan of a physical document or through the use of an algorithmic conversion of a known digital document type.

Databases of the systems of the present invention can do one or more of add capabilities of a receiving facsimile device when the capabilities are determined not to be in the database, update to reflect a change in capabilities associated with a receiving facsimile device and update to reflect a change in receiving-user preferences associated with a receiving facsimile device. In one embodiment of the systems of the present invention, the source document is reconverted to a facsimile document based on the changed preferences and/or capabilities associated with a receiving facsimile device.

In certain systems of the present invention, a preview of the facsimile compatible format of the source document is presented to a transmitting user. The preview can be supplied by, without limitation, a video display or a printed physical document. Facsimile transmittals can be terminated by a transmitting user or terminated independently of the transmitting user based on preselected attribute criteria selected from the group consisting of the color, resolution, baud rate, compression format, and combinations thereof.

In another embodiment of the systems of the present invention, the system is equipped to reiteratively execute a plurality of facsimile transmittals in a batch process. In another embodiment of the systems of the present invention, the conversion of the source document is optimized for each individual instance of the plurality of facsimile transmittals. In another embodiment of the systems of the present invention, the conversion of the source document is optimized for capabilities common to all instances of the plurality of facsimile transmittals.

It is to be understood that the present invention is not limited to the particular embodiments, materials, and examples described herein, as these can vary. It also is to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “a receiving facsimile device” or “a document” is a reference to one or more receiving facsimile devices or documents and includes equivalents thereof known to those skilled in the art and so forth.

Unless defined otherwise, all technical terms used herein have the same meanings as commonly understood by one of ordinary skill in the art to which this invention belongs. Specific methods, devices, and materials are described, although any methods and materials similar or equivalent to those described herein can be used in the practice or testing of the present invention.

What is claimed is:

1. A method comprising:
providing a database capable of storing data regarding specified capabilities of a plurality of receiving facsimile devices wherein said database links said specified capabilities of said receiving facsimile devices with each said receiving facsimile device's unique addressing identifier;
enabling a database management device to link to said database wherein said database management device processes said data stored in said database;
allowing a transmitting facsimile device to communicate a unique addressing identifier to said database management device through a mutual data communication network wherein said database management device then determines said specified capabilities of said receiving facsimile device associated with said communicated unique addressing identifier by referencing said stored data within said database and communicates said specified capabilities of said receiving facsimile device to said transmitting facsimile device.

2. A method according to claim 1 wherein said database is further capable of storing and linking receiving-user preferences within the particular receiving user's receiving facsimile device's capabilities for use during facsimile transmission.

3. A method according to claim 1 or 2, wherein a transmitting user supplies said transmitting facsimile device with a source document for transmittal to said receiving facsimile device; and
wherein said transmitting facsimile device converts said source document to a facsimile compatible format within said specified capabilities (and receiving-user preferences if available) of said receiving facsimile device and said native capabilities of said transmitting facsimile device.

4. A method according to claim 3, wherein said transmitting facsimile device further transmits said converted document to said receiving facsimile device.

5. A method according to claim 1, wherein said database does one or more of:
adding capabilities of a receiving facsimile device when said capabilities are determined not to be in said database; updating to reflect a change in capabilities associated with a receiving facsimile device; and updating to reflect a change in receiving-user preferences associated with a receiving facsimile device.

6. A method according to claim 3, wherein a preview of said converted facsimile document is provided to said transmitting user.

7. A method according to claim 3, wherein said transmitting user can terminate said facsimile transmittal or wherein said facsimile transmittal is terminated independently of said transmitting user based on preselected attribute criteria.

8. A system comprising:
a database capable of storing data regarding specified capabilities of a plurality of receiving facsimile devices wherein said database links said specified capabilities of said receiving facsimile devices with each said receiving facsimile device's unique addressing identifier; and
a database management device to link to said database wherein said database management device processes said data stored in said database, wherein a transmitting facsimile device can communicate a unique addressing identifier to said database management device through a mutual data communication network, wherein said database management device then determines said specified capabilities of said receiving facsimile device associated with said unique addressing identifier by referencing said stored data within said database and communicates said specified capabilities of said receiving facsimile device to said transmitting facsimile device.

9. A system according to claim 8 wherein said database is further capable of storing and linking receiving-user preferences within the particular receiving user's receiving facsimile device's capabilities for use during facsimile transmission.

10. A system according to claim 8 or 9, wherein said transmitting facsimile device converts a source document to a facsimile compatible format within said specified capabilities (and receiving-user preferences if available) of said receiving facsimile device and said native capabilities of said transmitting facsimile device.

11. A system according to claim 8, wherein said database can do one or more of:
add capabilities of a receiving facsimile device when said capabilities are determined not to be in said database; update to reflect a change in capabilities associated with a receiving facsimile device; and update to reflect a change in receiving-user preferences associated with a receiving facsimile device.

12. A system according to claim 10, wherein a facsimile transmittal can be terminated by a transmitting user or terminated independently of said transmitting user based on preselected attribute criteria selected from the group consisting of the color, resolution, baud rate, compression format, and combinations thereof.

13. A system according to claim 10 wherein a preview of said facsimile compatible format of said source document is presented to a transmitting user.
